(19) United States
(12) Patent Application Publication
(10) Pub. No.: US 2020/0072627 A1
(43) Pub. Date: Mar. 5, 2020

(54) DEVICE, METHOD AND SYSTEM FOR ROUTE PLANING FOR AN ELECTRIC VEHICLE

(71) Applicant: ZF FRIEDRICHSHAFEN AG, Friedrichshafen (DE)

(72) Inventors: Andreas Jung, Schlier (DE); Philipp Notheis, Salem-Mimmenhausen (DE)

(73) Assignee: ZF FRIEDRICHSHAFEN AG, Friedrichshafen (DE)

(21) Appl. No.: 16/557,241

(22) Filed: Aug. 30, 2019

(30) Foreign Application Priority Data
Sep. 4, 2018 (DE) 102018214986.0

(51) Int. Cl. G01C 21/34; B60L 53/66; B60L 58/12

(52) U.S. Cl. CPC G01C 21/3469; G01C 21/3476; G01C 21/3407; B60L 58/12; B60L 53/665

(57) ABSTRACT

The present disclosure relates to a device for route planning for an electric vehicle, comprising: an input interface for receiving an up-to-date charge level of an energy storage of the electric vehicle and a planned route for the electric vehicle; a database interface for receiving charging station information with locations of charging stations; an energy planning unit for determining an estimated status of the charge level of the energy storage, based on the up-to-date charge level of the energy storage and the planned route; a charging planning unit for selecting a charging station based on the estimated status of the charge level, the charging station information and the planned route; a customization module for determining at least one customized route passing through the location of the selected charging station based on the planned route.

### CROSS-REFERENCE TO RELATED APPLICATIONS

This application claims priority to German Patent Application Serial No. 102018214986.0, filed Sep. 4, 2018, the full disclosure of which is incorporated herein by reference in entirety.

### TECHNICAL FIELD

The present disclosure relates to a device, a method, a system, and a navigation unit for route planning for an electric vehicle.

### BACKGROUND

Most road users nowadays use route planning or navigation units to reach a destination. Such devices may be implemented in a vehicle equipped with a combined vehicle information system and an entertainment system. Alternatively, there are also individually designed devices that, for example, while attached to the windshield of a car, allow a simple subsequent installation. Moreover, an equivalent functionality can also be carried out by a mobile phone or tablet with the relevant software (App).

In most cases, current navigation units have an internal or external position sensor, such as a GPS receiver, which allows identification and tracking of their own position. Entering a destination position is normally done by the driver in a manual manner, for example via a keyboard, a touch screen or a voice input. By using the own position as the start position and the entered destination position, a route is then planned based on the appropriate prepared maps. While driving, visual and/or acoustic instructions are provided to the driver to follow the determined route in order to reach the destination position.

Due to political guidelines and technological developments, the importance of electromobility is increasing. Although until recently there was only an insignificant number of electrically-powered vehicles on the road, there is nowadays a steadily growing number of electric vehicles such as electric cars, electric trucks or electric two-wheelers for a wide range of applications. This development requires the provision of an appropriate charging infrastructure for charging electric vehicles.

In contrast to vehicles with internal combustion engines fuelled with gasoline or diesel, electric vehicles typically require a more constant charging frequency (less travel range) and also longer charging times. For example, battery charging times for electric cars using standard plugs are often given one to four hours for a full charge. An insufficient number of charging stations can cause waiting times during charging and considerable delays in a journey. In addition, there are often different coupling systems (plugs), meaning that there may not be compatibility between the charging interface of the electric vehicle and the interface of the charging station. The availability of charging stations is regarded as a central factor for the further spread of electromobility.

In this context, WO 2017/092817 A1 relates to a charging system for vehicles. A system for exchanging supply media comprises at least one exchange station with an exchange interface for exchanging a supply medium.

In this respect, a new challenge occurs when selecting an optimal route for using an electric vehicle. On the one hand, a sufficient number of sufficiently long charging stops must be scheduled, on the other hand, other criteria must be taken into account, such as, the shortest possible travel time, low cost, and personal preferences of the driver. In previous approaches the driver of an electric vehicle was often required to evaluate how to reach a charging station at the most convenient possible time. The travel range of the electric vehicle should be used as far as possible to ensure a short travel time. However, it must also be ensured that a charging station is reached in a timely manner.

### SUMMARY

Based on this, the present disclosure has the purpose to further improve the route planning for an electric vehicle. The need for the driver to interact manually should be reduced. In particular, the travel time of the electric vehicle should be reduced and the comfort for the driver increased.

To achieve this purpose, one aspect of the present disclosure relates to a device for route planning for an electric vehicle, comprising: an input interface for receiving an up-to-date charge level of an energy storage of the electric vehicle and a planned route for the electric vehicle; a database interface for receiving charging station information with locations of charging stations; an energy planning unit for determining an estimated status of the charge level of the energy storage based on the up-to-date charge level of the energy storage and the planned route; a charge planning unit for selecting a charging station based on the status of the charge level, the charging station information and the planned route; and a customization module for determining at least one customized route passing through the location of the selected charging station, based on the planned route.

Furthermore, one aspect of the present disclosure relates to a method for route planning for an electric vehicle, comprising the following steps: Receiving an up-to-date charge level of the energy storage of an electric vehicle and a planned route for the electric vehicle; Receiving charging station information with locations of charging stations; Determining an estimated status of the charge level of the energy storage based on the up-to-date charge level of the energy storage and the planned route; Selecting a charging station based on the estimated status of the charge level, the charging station information and the planned route; and Determining at least one customized route passing through the location of the selected charging station, based on the planned route. In addition, one aspect of the present disclosure relates to a navigation unit comprising a device as described above and a route planning unit for determining a route from a start position to a destination position.

Another aspect relates to a system for route planning for an electric vehicle, comprising: a device as described above; an energy storage of an electric vehicle to store energy; a database to provide information on charging stations; and a route planning unit for determining a route from a start position to a destination position.

Preferred embodiments of the present disclosure are described in the dependent claims. It is understood that the features mentioned above, including those features to be explained below, are used not only in each specified combination, but also in other combinations or by themselves, without exceeding the bounds of the present disclosure. In particular, the device, the method, the navigation unit, the system and the computer program product may be implemented according to the described embodiments in the dependent claims pertaining to the device and the system.

The present disclosure is based on the fact that while route planning for an electric vehicle, at least the following two factors are taken into account: the locations of charging stations for charging the energy storage and the estimated development of the charge level of the energy storage of the electric vehicle. First, the up-to-date charge level, i.e. the level of the energy storage of the electric vehicle, and also a (pre-) planned route are received. Then, information on charging stations is received from a database including at least the locations of charging stations. Based on the planned route and the up-to-date charge level of the energy storage, it is determined how this charge level is expected to develop when driving along the planned route. Then, a prediction is made for determining at which point in time there is still remaining amount of energy in the energy storage. In this case in particular, the distance traveled is taken into account, but also other information on the planned route can be included. Finally, based on this prediction and the information on charging stations, the planned route is customized, in order to pass through a selected charging station where the energy storage can be charged. Then, via an automated process a suitable charging station is suggested, and the previously determined route is changed accordingly, so that this selected charging station is reached. As a result, a customized route is provided with a suggested charging station for charging the energy storage.

In contrast to previous approaches, it is not necessary for the driver of the electric vehicle to manually plan the required charging process. Previous approaches, such as an App-based database with available charging stations including their locations, required that the driver made a manual choice. In contrast to this, according to the present disclosure it is provided to use the available information on the charge level and the distance, in order to automatically determine and suggest an optimal charging station. The planned route will be modified to reach the proposed charging station, without the driver having to intervene. The travel time is minimized and the need to frequently charge the energy storage is avoided. An optimized route with respect to travel time is determined.

In a preferred embodiment, the device comprises a user interface for providing the user with at least one customized route, and for receiving a selected route that was selected by the user. Preferably, a plurality of possible customized routes are determined, which may pass through different charging stations. In order that the user (e.g. the driver of the electric vehicle) is able to make a choice, then an interaction via a user interface (reading options, and entering the choice made by the user) will occur. In contrast to previous approaches, route suggestions with pre-planned intermediate stops at charging stations are given. Due to the selection options the user can additionally introduce his own preferences (for example, by selecting a road distance that is shorter, but slightly more time-consuming than a possible motorway route).

In a further preferred embodiment, the user interface is designed for providing additional information on the at least one customized route, including preferably the electricity price at the selected charging station. Via the user interface it is possible to provide further information related to the planned route. In particular, it is possible to additionally provide information on the electricity price at different selected charging stations. Such additional information may also be obtained from a corresponding database via the database interface, for example. The user of the electric vehicle will make his own assessment. For example, the additional information may include the electricity price at the selected charging station, while the corresponding information may also be obtained for this purpose preferably via the database interface. The user will be able to add his own preferences in addition to the automatically suggested route. There are more flexible options when selecting the route.

In a further advantageous embodiment, the device includes a reservation unit for determining an estimated arrival time at the selected charging station and for reserving the selected charging station at the estimated arrival time, wherein the reservation unit preferably comprises a mobile communication unit for mobile communication with a reservation service for managing charging periods of charging stations. Charging stations can be reserved via the reservation unit as soon as an estimated arrival time is determined. For this purpose, preferably via the mobile communication unit a mobile phone connection is established with a corresponding service. For example, a reservation can be made via a corresponding Internet service. The term “management of charging periods” will be understood in particular here as management of reservations through which various requests are coordinated according to the available resources. Long waiting times at charging stations are avoided. In addition, the user experience is further enhanced.

More preferably, the database interface is designed for receiving information on charging stations including the available plug types of such charging stations and/or including data on reservations of charging stations made by other road users. In addition to the locations of the charging stations, additional information about the charging station can be received and incorporated. In particular, the information may include available plug types, that is, descriptions of the charging interfaces of the charging stations, or reservation information, i.e. information about the occupancy of the charging station by other vehicles. This additional information is then taken into account by the charging planning unit when selecting a suitable charging station and when customizing at least one planned route. Through the extra consideration of further information, selecting a suitable and preferred charging station can be improved. The comfort for the driver or user of the device is increased. Due to lack of standardization, there are often different types of plugs at charging stations. It is prevented that a charging station is proposed, where a plug system for the electric vehicle is not available.

More advantageously, the input interface and/or the database interface is designed for receiving environment information with data on the surroundings of the electric vehicle, wherein the environment information includes in particular weather data, temperature data, traffic data, and/or route condition data. The energy planning unit is also designed to determine the estimated status of the charge level of the energy storage based on the environment information. When predicting the charge level of the energy storage, additional information can be taken into account in order to increase the prediction reliability. Especially considering the environment information, such as weather, temperature, traffic and/or the route condition along the planned route, the accuracy for determining the estimated status of the charge level can be increased. For example, the energy consumption usually increases in cold weather by the fact that the occupants of the electric vehicle turn on the heating. Due to an increased prediction accuracy, a corresponding safety margin can be reduced, so that the travel time can be further reduced by better utilization of the available energy.

More preferably, the database interface is designed for receiving user information with data about a user, wherein the user information preferably comprises time limits and/or preferred leisure activities of the user. The charge planning unit is also designed for selecting the charging station based on the user information. Through the utilization of user information, it is possible that the preferences including individual instructions or likes of a user are taken into account. For example, a charging station that is next to a movie theater, can be suggested to a user who enjoys going to the movie theater. The selection of the charging station is more individualized and customized to suit specific requirements, so that the comfort of the user is further improved.

In one embodiment, the charging planning unit is designed for determining a required charging time at the selected charging station based on at least one customized route. It is possible that in each case the required charging time is customized individually. For example, a charging time during which the energy storage is only partially charged, may be sufficient for the rest of the route. The required charging time is determined or optimized individually based on the planned route. In this way, a further reduction in travel time can be achieved, since only a minimum charging time takes place at the charging station along the route and the complete recharge is moved to a point in time after reaching the destination.

In a preferred embodiment, the charge planning unit is designed for performing a multi-criteria optimization method. The term “multi-criteria optimization method” is understood as a method in which different objectives, such as a short travel time, a fast journey, a known preference of the user, a favorable price for charging the energy storage, etc. are considered. In most cases, an evaluation function and/or weighting function is provided, via which each individual criterion is given a rate, so that an optimum can be achieved when selecting the charging station based on a predefined weighting of various factors. It is understood that it is possible for a user to define this pre-known weighting individually, so that an individually, optimized selection of a charging station can be made. The convenience for the user is optimized.

In a preferred embodiment of the route planning system according to the present disclosure, the system comprises a server for running a reservation service in order to manage charging periods of charging stations. The charging times or charging slots at the individual charging stations are preferably managed by an Internet-based reservation service (cloud reservation service). This reservation service responds to requests from different users and manages the resources, i.e. the charging times at the different charging stations. This ensures the use of up-to-date information.

The term electric vehicle is understood herein as all types of fully electric and partially electric (hybrid electric) driven vehicles with rechargeable energy storages, such as electric cars, electric trucks, or electric two-wheelers. In particular, the term electric vehicle refers herein to electrically driven vehicles with a battery as energy storage. However, the term electric vehicle herein may also include electrically driven vehicles with a fuel cell as energy storage. The term charge level is understood herein as an absolute or relative (with reference to a maximum storable amount of energy) indication of a remaining amount of energy in the energy storage. The term location specification is understood as a unique (absolute or relative) indication of a place, for example in the form of coordinates. The location of a charging station thus corresponds to a specification of the position of the charging station. The term status of the charge level is understood as the development of the charge level over time or over distance.

### BRIEF DESCRIPTION OF THE DRAWINGS

The present disclosure will be described and explained in more detail with reference to some selected embodiments in connection with the accompanying drawings. Shown below:

FIG. 1 a schematic representation of a device according to the present disclosure for route planning for an electric vehicle;

FIG. 2 a schematic representation of a system according to the present disclosure;

FIG. 3 a representation of a planned route from a start position to a destination position before and after a customization for reaching a selected charging station;

FIG. 4 a schematic representation of a device according to the present disclosure with further optional components; and

FIG. 5 a schematic representation of a method according to the present disclosure for route planning for an electric vehicle.

### DETAILED DESCRIPTION

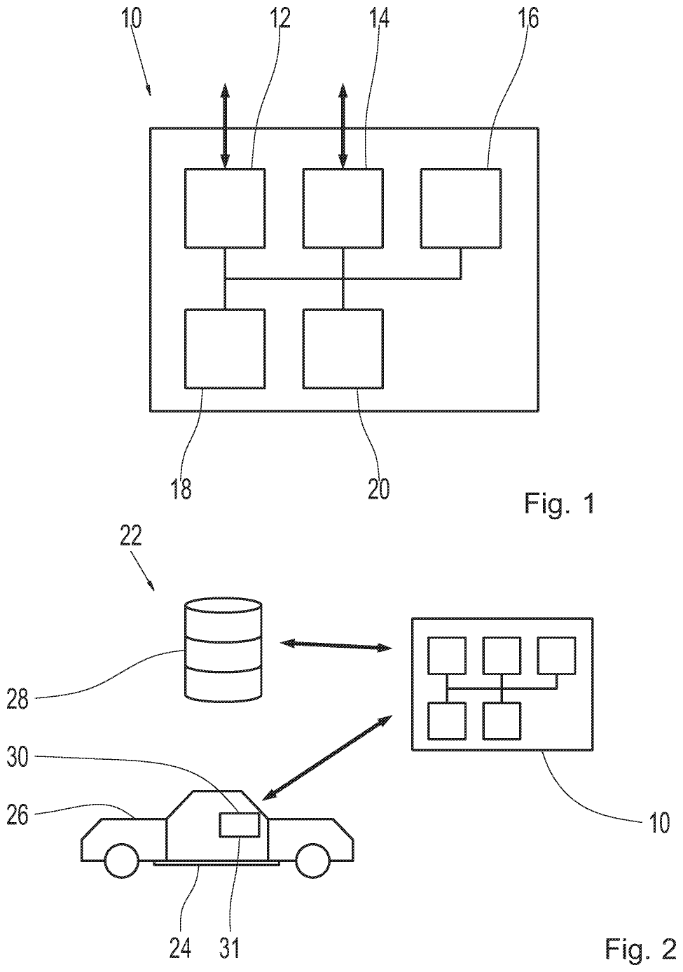

In FIG. 1, a device according to the present disclosure 10 is shown for route planning for an electric vehicle according to the present disclosure. The device 10 includes an input interface 12, a database interface 14, an energy planning unit 16, a charging planning unit 18, and a customization module 20. The device 10 allows to customize a pre-planned route for passing through a charging station where the energy storage of the electric vehicle can be charged. The determination of at least one customized route is, on the one hand, based on an estimated status of the charge level of the energy storage, i.e. a prediction of the energy consumption of the electric vehicle during the journey along the route; and, on the other hand such determination is based on charging station information, which in particular includes the locations of the possible charging stations. By the automated and formalized selection of a charging station or determination of a customized route, through which such selected charging station is reached, the user of the device 10 or the driver of the electric vehicle can be deviated for re-planning the route due to a necessary recharging of the energy storage on the journey. This improves, on the one hand, the comfort during driving, and on the other hand, the travel time is shortened or optimized.

The input interface 12 receives an up-to-date charge level of an energy storage of the electric vehicle and a planned route for the electric vehicle. The input interface corresponds in particular to a communication interface for communication with a vehicle information system through which the charge level of the energy storage is transmitted, and also for communication with a navigation unit or a corresponding navigation software through which a planned route is transmitted. The up-to-date charge level can be given, for example, as an absolute energy indication (kWh or kg of hydrogen, etc.) or can be specified as a relative indication (percentage) with respect to a previously known total capacity. The planned route is preferably received in a corresponding data format. In this case the input interface can be used for both wireless and wired communication. The communication can take place in a unidirectional or bidirectional manner. For example, the input interface may be used as a Bluetooth module or as a Micro-USB connector.

The database interface 14 is used for receiving charging station information with locations of charging stations. These locations of charging stations correspond to location information of facilities where the energy storage of the electric vehicle can be recharged. In particular, the locations of charging stations may include coordinates or other corresponding information on the location of charging columns for charging a battery of an electric vehicle. The database interface 14 may also be designed for wireless or wired, unidirectional or bidirectional communication. In particular, the database interface 14 may allow an Internet connection, so that the charging station information can be received from the Internet from a corresponding Internet server. For example, the database interface 14 may be designed as a mobile unit.

The energy planning unit 16 allows to determine an estimated status of the charge level of the energy storage based on the up-to-date charge level of the energy storage and the planned route. In other words, a prediction is made about the future development of the content of the energy storage. For this purpose, the planned route is assessed. In particular, the distance traveled is analyzed. However, other parameters such as gradients or slopes, etc. can also be considered, meaning that such parameters have an impact on the energy consumption when driving on the planned route. It is understood that the more accurate the prediction is, the more relevant information is taken into account. In addition, it is understood that the prediction for the near future is more accurate than for a distant future. The chronological status of the charge level is predicted or determined. The energy planning unit 16 may be designed for example as a microprocessor.

Based on this estimated status of the charge level on the charging station information including the positions of charging stations and on the planned route, then a charging station is selected in the charging planning unit 18. For this purpose, for example, a multi-criteria optimization method can be carried out, via which various objectives are given different weighting. Thus, on the one hand, it can be taken into account that the maximum travel range of the electric vehicle will be sufficient to reach the selected charging station with a safe probability, based on the current and predicted charge level of the energy storage. On the other hand, it can be taken into account that only the smallest possible deviation from the planned route is necessary to reach the selected charging station. This minimizes the loss of time to reach the selected charging station. In most cases, it should be ensured that during the journey as few interruptions as possible are required to charge the energy storage.

In the customization module 20, the original planned route is then customized so that it is directed via the selected charging station. Normally, the customized route mainly corresponds to the originally planned route. A deviation results from the fact that the selected charging station, which is usually located in the vicinity of the planned route is additionally reached after being taken into account in the customized route. The customized route can then serve as a basis for the navigation of the electric vehicle. The energy planning unit 1, the charging planning unit 18 and the customization module are designed, for example, together or separately as a processor.

In FIG. 2, a system 22 according to the present disclosure for route planning for an electric vehicle is shown schematically. The system includes a device 10, an energy storage 24 of an electric vehicle 26, a database 28, and a route planning unit 30.

In the illustrated embodiment, the device 10 is designed as a Smartphone with the appropriate App and communicates with a route planning unit 30, which is located within the electric vehicle 26. It is also possible that the device 10 is designed as part of a vehicle information and entertainment system as part of a navigation unit or designed in another manner. The device 10 communicates via the input interface with the energy storage 24 of the electric car 26, as well as with the route planning unit 30. Via the database interface the device 10 communicates with the database 28. The communication with the energy storage 24, and the route planning unit 30 can take place, for example, via a wireless short-range communication (Bluetooth or similar). The communication with the database 28 usually takes place via a mobile connection.

In the illustrated embodiment of the system 22 according to the present disclosure, the electric vehicle 26 comprises an energy storage 24. In particular, the energy storage 24 may be a battery. The energy storage 24 is filled or charged via a corresponding interface, in particular via a cable at a corresponding charging station. This charging process usually takes much longer than the tank filling with gasoline for a vehicle with an internal combustion engine. A full charging process to charge a battery can take several hours.

In the illustrated embodiment of the system 22, the electric vehicle 26 comprises the route planning unit 30, which is integrated for example in a navigation unit 31. But it is also possible that the route planning unit 30 is implemented in software, and also developed as a Smartphone App or as an Internet-based service. The route planning unit 30 is used to plan a route from a start position to a destination position. The navigation unit 31 is used to provide the user or the driver of the electric vehicle 26 with navigation information.

The database 28 is located in the illustrated embodiment away from the electric vehicle 26 and the device 10 and is in a communication connection with the device 10. For example, the database 28 may be an Internet-based database (Cloud database), which is constantly updated to keep the latest information about the charging stations.

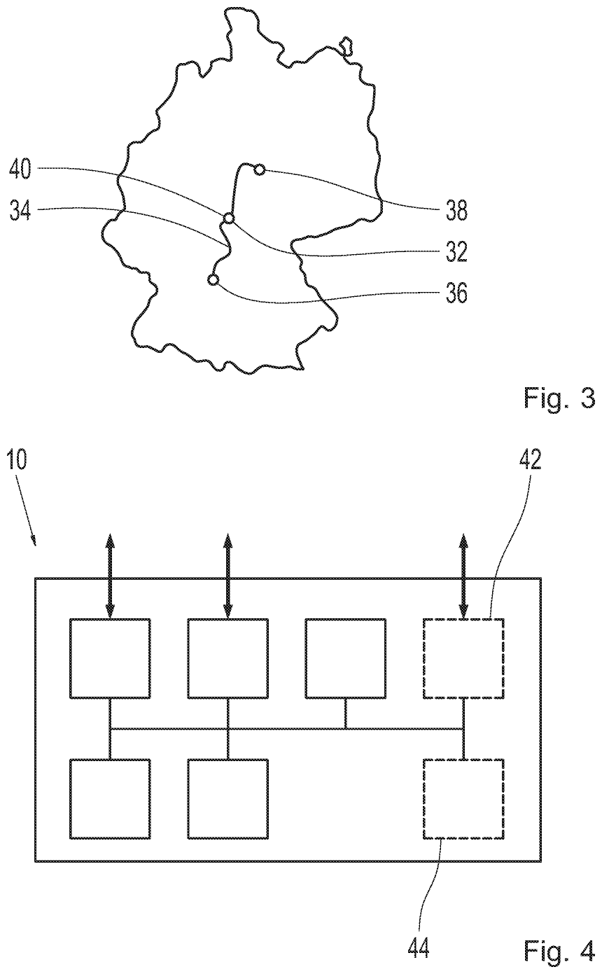

In FIG. 3, an example of a planned route 32 and a customized route 34 are shown. In order to get from a start position 36 to a destination position 38, a planned route 32 is first determined in a route planning unit. This is then customized in the device to determine a customized route 34, via which a selected charging station 40 is reached. Thus an intermediate stop at a charging station 40 is included. The planned route 32 and the customized route 34 differ in that an intermediate destination is inserted, where charging the energy storage of the electric vehicle is possible. This can lead to a greater or lesser deviation from the originally planned route 32, depending on the area through which the route runs, and on the density of charging stations located in such area. It is understood that depending on the length of the distance and depending on the size of the energy storage, more than one intermediate stop is required for charging the energy storage and therefore several charging stations are selected in the charge planning unit. In addition, it is understood that several possible customized routes are determined.

In FIG. 4, a further embodiment of the device 10 according to the present disclosure is shown schematically. In addition to the previously explained units, the device 10 may optionally comprise a user interface 42. This user interface is used to allow a user to select between several customized routes. A number of customized routes are offered to the user, after which the choice made by the user is received. For example, the user interface 42 can be implemented for this purpose as a touch screen display.

Furthermore, the device 10 may optionally comprise a reservation unit 44. This reservation unit is used to determine an estimated arrival time at the selected charging station and to make a reservation of the selected charging station. Therefore, a charge station is reserved. For this purpose, the reservation unit 44 may include mobile communication, in particular via a mobile Internet connection, with an internet-based reservation service through which charging periods are managed at charging stations. The reservation unit then transmits a request and receives a confirmation or a rejection. In this way, the device according to the present disclosure is suitable to determine in advance an expected arrival time at a selected charging station, thus a reservation of a charging station can be made at the required point in time. This prevents long waiting times at the selected charging station. Depending on the embodiment, different management principles can be used to manage the charging periods.

It is understood that the database or other device may contain additional information about the available charging stations. Such additional information can then be considered in the device when selecting the charging station.

For example, it can be taken into account plug types, i.e. interface types that are available for charging the energy storage at a specific charging station. In the field of battery-powered electric vehicles, there are different interfaces and different charging concepts. It will not be useful for the driver of an electric vehicle to stop at a charging station where no corresponding interface is available for charging his own energy storage.

In addition, it is possible that reservations of the charging station made by other road users are already taken into account when selecting the charging station. For this purpose, corresponding data on reservations of the charge station can be received via the database interface. These are then also taken into account when selecting the charging station in the charge planning unit. Therefore, a charging station is avoided, which is already fully reserved and is not available for charging the own electric vehicle.

It is also possible that user information is additionally received via the database interface (or via the user interface). This user information describes the user's preferences. For example, a user who enjoys going to a movie theater may want to select a charging station that is close to a movie theater. These preferences or likes of the user (user information) are then taken into account when selecting the charging station in the charging planning unit. In this respect, another optimization problem is determined. An optimal charging station is selected for a user, being such station individually tailored to his or her needs and preferences.

Furthermore, it is possible that ambient information is received via the input interface and/or via the database interface and that such ambient information is taken into account when determining the estimated status of the charge level of the energy storage. Thus, by taking into account environmental information such as data on temperature, weather, route condition or route traffic, a higher accuracy can be achieved in the prediction of the status of the charge level. In cold weather a battery is discharged faster. In warm weather, it may be necessary to use the air conditioning more often. As a data source, sensors on the electric vehicle or within the electric vehicle can be used for providing available information (temperature sensors, camera data, humidity sensors, etc.). It is also possible that information is requested by a corresponding service, for example via the Internet (weather forecasts, traffic and congestion information, route status information, etc.).

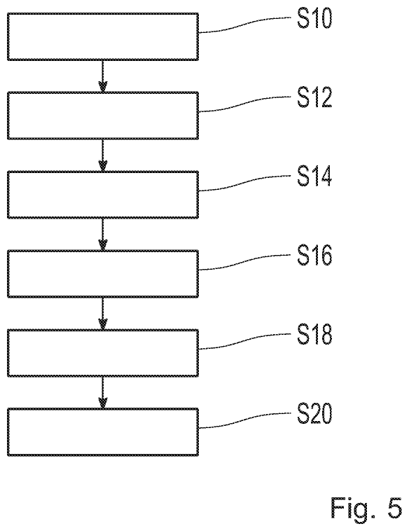

In FIG. 5, a method according to the present disclosure for route planning for an electric vehicle is shown schematically. First, these steps are performed: receiving S10 an up-to-date charge level and receiving S12 charging station information. Then, the following steps are included: determining S14 an estimated status of the charge level, selecting S18 a charging station and determining S20 at least one customized route. The method can be implemented in particular as a software product or as a computer program product.

The present disclosure has been comprehensively described and explained with reference to the drawings and the description. The description and explanation are to be understood as an example but not restricted to it. The present disclosure is not limited to the disclosed embodiments. Other embodiments or variations become apparent to those skilled in the use of the present disclosure and in the accurate analysis of the drawings, the disclosure and the subsequent claims.

In the patent claims, the words “include/including—comprise/comprising” and “with” do not exclude the presence of other elements or steps. The indefinite article “a” or “an” does not exclude the presence of a plurality. A single element or a single unit may perform the functions of several of the units mentioned in the patent claims. An element, a unit, a device and a system may be implemented partially or fully in hardware and/or in software. The mere mention of some actions in various different dependent patent claims is not to be interpreted as meaning that a combination of these actions cannot also be used advantageously. A computer program can be stored/distributed on a non-volatile disk, for example on an optical memory or on a semiconductor drive (SSD). A computer program can be distributed with hardware and/or as part of a hardware, for example via the Internet or via wired or wireless communication systems. Reference numerals in the patent claims are not intended to be restrictive.

What is claimed is:

1. A device for route planning for an electric vehicle, comprising:
an input interface for receiving an up-to-date charge level of an energy storage of the electric vehicle and a planned route for the electric vehicle;
a database interface for receiving charging station information with locations of charging stations;
an energy planning unit for determining an estimated status of the charge level of the energy storage based on the up-to-date charge level of the energy storage and the planned route;
a charging planning unit for selecting a charging station based on the estimated status of the charge level, the charging station information and the planned route; and
a customization module for determining at least one customized route passing through the location of the selected charging station based on the planned route.

2. The device according to claim 1, comprising a user interface for providing the user with the at least one customized route, and for receiving a selected route that was selected by the user.

3. The device according to claim 2, wherein
the user interface is designed for providing additional information on the at least one customized route; and
the additional information preferably includes the electricity price at the selected charging station.

4. The device according to claim 3, comprising:
a reservation unit for determining an estimated arrival time at the selected charging station and for reserving the selected charging station at the estimated arrival time,
wherein the reservation unit preferably includes a mobile communication unit for mobile communication with a reservation service to manage the charging periods of the charging stations.

5. The device according to claim 2, wherein the database interface is designed for receiving the charging station information with available plug types of the charging stations and/or with data on reservations of the charging stations made by other road users.

6. The device according to claim 2, wherein one of the input interface and the database interface is designed for receiving environment information with data on the surroundings of the electric vehicle, wherein the environment information includes in particular weather data, temperature data, traffic data, and/or route condition data; and
the energy planning unit is also designed for determining the estimated status of the charge level of the energy storage based on the environment information.

7. The device according to claim 2, wherein
the database interface is designed for receiving user information with data about a user, wherein the user information preferably comprises time limits and/or preferred leisure activities of the user; and
the charge planning unit is also designed for selecting the charging station based on the user information.

8. The device according to claim 2, wherein the charging planning unit is designed for determining a required charging time at the selected charging station based on the at least one customized route.

9. The device according to claim 2, wherein the charge planning unit is designed for performing a multi-criteria optimization method.

10. A system for route planning for an electric vehicle, comprising:
a device for route planning for an electric vehicle further including:
an input interface for receiving an up-to-date charge level of an energy storage of the electric vehicle and a planned route for the electric vehicle;
a database interface for receiving charging station information with locations of charging stations;
an energy planning unit for determining an estimated status of the charge level of the energy storage based on the up-to-date charge level of the energy storage and the planned route;
a charging planning unit for selecting a charging station based on the estimated status of the charge level, the charging station information and the planned route; and
a customization module for determining at least one customized route passing through the location of the selected charging station based on the planned route;
an energy storage device of an electric vehicle to store energy;
a database for providing charging station information; and
a route planning unit for determining a route from a start position to a destination position.

11. The system according to claim 10, comprising a server for running a reservation service in order to manage charging periods of charging stations.

12. A method for route planning for an electric vehicle, comprising the steps of:
Receiving an up-to-date charge level of an energy storage of the electric vehicle and a planned route of the electric vehicle;
Receiving charging station information with locations of charging stations;
Determining an estimated status of the charge level of the energy storage based on the up-to-date charge level of the energy storage and the planned route;
Selecting a charging station based on the estimated status of the charge level, the charging station information and the planned route; and
Determining at least one customized route passing through the location of the selected charging station, based on the planned route.
